(19) United States
(12) Patent Application Publication
(10) Pub. No.: US 2005/0001961 A1
(43) Pub. Date: Jan. 6, 2005

(54) Display

(75) Inventors: Norio Koma, Motosu-gun (JP); Shinji Ogawa, Ogaki-shi (JP); Kazuyuki Maeda, Nishikasugai-gun (JP); Nobuhiko Oda, Hashima-shi (JP); Kazuhiro Inoue, Mizuho-shi (JP); Tsutomu Yamada, Mizuho-shi (JP); Masahiro Okuyama, Inazawa-shi (JP)

Correspondence Address: McDERMOTT, WILL & EMERY, 600 13th Street, N.W., Washington, DC, 20005-3096, US

(73) Assignee: SANYO ELECTRIC CO., LTD.

(21) Appl. No.: 10/826,388

(22) Filed: Apr. 19, 2004

(30) Foreign Application Priority Data
Apr. 25, 2003 (JP) JP2003-120904
Jun. 4, 2003 (JP) JP2003-158932

(51) Int. Cl. G02F 1/1335

(52) U.S. Cl. 349/114

(57) ABSTRACT

There is provide a display which can prevent lowering of display quality caused by fluctuation of thickness of an orientation film. The display includes a display region having a reflective region and a transmissive region and comprises a first region having a convex insulating film formed in a region corresponding to the reflective region on a substrate, and an orientation film formed so as to cover the convex insulating film. A second region in which the convex insulating film is not formed is continuously formed among adjacent pixels.

### BACKGROUND OF THE PRESENT INVENTION

1. Field of the Invention

The present invention relates to a display and more particularly, it relates to a display including a display region having a reflective region and a transmissive region.

2. Description of the Background Art

Conventionally, in a transflective type of liquid crystal display, there has been proposed a structure in which a distance (light path length) in which light input to a transmissive region passes through a liquid crystal layer and a distance (light path length) in which light input to a reflective region passes through a liquid crystal layer are made equal by providing a convex insulating film in a region corresponding to the reflective region. This is disclosed in Japanese Unexamined Patent Publication No. 2002-98951, for example.

FIG. 25 is a plan view showing a structure of the transflective type of liquid crystal display having a convex insulating film. FIG. 26 is a sectional view showing the conventional display shown taken along line 300-300 in FIG. 25. FIG. 27 is a schematic view showing a planar configuration of the convex insulating film in the conventional display shown in FIG. 25.

The conventional transflective type of liquid crystal display comprises a reflective region 390a and a transmissive region 390b as shown in FIG. 26. A semiconductor layer 302 constituting a thin film transistor TFT and a semiconductor layer 303 functioning as an auxiliary capacity electrode are formed in predetermined regions on a glass substrate 301 in the reflective region 390a. The semiconductor layer 302 is formed into a horseshoe shape in a plan view as shown in FIG. 25. The horseshoe-shaped semiconductor layer 302 comprises two source regions 302a, two drain regions 302b, and two channel regions 302c as shown in FIG. 26. The source region 302a and the drain region 302b are arranged so as to sandwich the channel region 302c.

In addition, two gate electrodes 305 are formed on the two channel regions 302c on the semiconductor layer 302 through a gate insulating film 304. One gate electrode 305, one source region 302a, one drain region 302b, one channel region 302c and the gate insulating film 304 constitute one TFT. In addition, the other gate electrode 305, the other source region 302a, the other drain region 302b, the other channel region 302c and the gate insulating film 304 constitute the other TFT. In addition, an auxiliary capacity electrode 306 is formed on the semiconductor layer 303 through the gate insulating film 304. Thus, the semiconductor layer 303, the gate insulating film 304, and the auxiliary capacity electrode 306 constitute an auxiliary capacity.

In addition, as shown in FIG. 25, a gate line 305a formed of the same layer as that of the gate electrode 305 and extending in the predetermined direction is connected to the two gate electrodes 305. In addition, an auxiliary capacity line 306a formed of the same layer as that of the auxiliary capacity electrode 306 and extending in the direction parallel to the gate line 305a is connected to the auxiliary capacity electrode 306.

As shown in FIG. 26, an interlayer insulating film 307 is formed so as to cover the TFT and the auxiliary capacity. In addition, contact holes 307a, 307b and 307c are formed in regions corresponding to the source region 302a, the drain region 302b and the semiconductor layer 303 in the interlayer insulating film 307 and the gate insulating film 304, respectively. Then, a source electrode 308 is formed so as to be electrically connected to the source region 302a through the contact hole 307a. In addition, a part 308b of the source electrode 308 is formed so as to be electrically connected to the semiconductor layer 303 through the contact hole 307c. A drain electrode 309 is formed so as to be electrically connected to the drain region 302b through the contact hole 307b. As shown in FIG. 25, a drain line 309a formed of the same layer as that of the drain electrode 309 and extending in the direction intersecting the gate line 305a at right angles is connected to the drain electrode 309.

In addition, as shown in FIG. 26, a convex insulating film 311 is formed in the predetermined region on the interlayer insulating film 307 so as to cover the source electrode 308 and the drain electrode 309. A contact hole 311a is formed in the convex insulating film 311 in the region corresponding to the source electrode 308. Then, a concave part 312 is formed by a side face of the convex insulating film 311 and an upper face of the interlayer insulating film 307 in which the insulating film 311 is not formed. In addition, the convex insulating film 311 is formed so as to correspond to the reflective region 390a and the concave part 312 is formed so as to correspond to the transmissive region 390b.

As shown in FIG. 27, the convex insulating film 311 is formed so as to surround the concave part 312 at each pixel region surrounded by the gate line 305a and the drain line 309a in the display region 390c. Therefore, the concave part 312 is formed so as to be separated at each pixel.

In addition, as shown in FIG. 26, a reflective electrode 313 is formed on the upper face of the convex insulating film 311 so as to be electrically connected to the source electrode 308 through the contact hole 311a. The reflective electrode 313 is formed so as to cover the TFT, the auxiliary capacity, the gate line 305a and the auxiliary capacity electrode 306a in the plan view shown in FIG. 25. As shown in FIG. 26, a transparent electrode 314 is formed on the inner face of the concave part 312 and on the surface of the reflective electrode 313. The transparent electrode 314 and the reflective electrode 313 constitute a pixel electrode. In addition, an orientation film 315 comprising polyimide is formed on the transparent electrode 314 constituting the pixel electrode.

A glass substrate (opposite substrate) 316 is provided at a position opposed to a glass substrate 301. A color filter 317 providing each color of red (R), green (G) and blue (B) is formed on the glass substrate 316. A transparent electrode 318 is formed on the color filter 317. An orientation film 319 comprising polyimide is formed on the transparent electrode 318. In addition, a liquid crystal layer 320 is provided between the orientation film 315 and the orientation film 319. In addition, an elliptical polarization film 321 is formed on the back face of the glass substrate 301 and the back face of the glass substrate (opposite substrate) 316, respectively.

According to the conventional transflective type of liquid crystal display, as shown in FIG. 27, since the convex insulating film 311 is formed so as to surround the transmissive region 390b (concave part 312), when the orientation film 315 comprising polyimide is formed on the transparent electrode 314 which reflects a concavo-convex configuration of the convex insulating film 311 and the concave part 312, polyimide stays in the concave region corresponding to the concave part 312 of each pixel. In this case, since an amount of polyimide staying in the concave region corresponding to the concave part 312 of each pixel is not uniform, polyimide constituting the orientation film 315 stays too much only in the concave region 312a corresponding to the concave part 312 at a part of the pixels as shown in FIG. 28, for example. Thus, when polyimide constituting the orientation film 315 stays too much only in the concave region 312a corresponding to the concave part 312 of a part of the pixels, the thickness of the orientation film 315 at each pixel is varied. As a result, there is a problem such that the display quality is lowered because of the fluctuation in thickness of the orientation film 315.

### SUMMARY OF THE PRESENT INVENTION

The present invention was made to provide a display which can prevent lowering of display quality caused by fluctuation in thickness of an orientation film.

In order to solve the above problems, a display according to a first aspect of the present invention includes a display region having a reflective region and a transmissive region and comprises a first region having a convex insulating film formed in a region corresponding to the reflective region on a substrate and an orientation film formed so as to cover the convex insulating film. A second region in which the convex insulating film is not formed is formed so as to be continuous among the adjacent pixels.

According to the display of the first aspect, when the orientation film is formed so as to cover the convex insulating film and the second region, a material constituting the orientation film can flow along the second region among the adjacent pixels. Thus, since the material constituting the orientation film is prevented from staying too much only in the second region of a part of the pixels, the orientation film can be uniformly formed in the second region at plural pixels and the thickness of the orientation can be substantially uniform in each pixel. As a result, the lowering of display quality caused by the fluctuation in thickness of the orientation film formed in the second region can be prevented.

A display according to a second aspect of the present invention includes a display having a reflective region and a transmissive region, consists of a plurality of pixels and comprises a first region in which a convex insulating film is formed in a region corresponding to the reflective region on a substrate, a second region in which the convex insulating film is not formed, an orientation film formed in common to the first region and second region, and the second region is continuously formed among the adjacent pixels.

According to the display of the second aspect of the present invention, when the orientation film is formed in common to the convex insulating film and the second region, a material constituting the orientation film can flow along the second region. Thus, since the material constituting the orientation film is prevented from staying too much only in the second region of a part of the pixels, the orientation film can be uniformly formed in the second region at plural pixels and the thickness of the orientation can be substantially uniform at each pixel. As a result, the lowering of display quality caused by the fluctuation in thickness of the orientation film formed in the second region can be prevented.

### BRIEF DESCRIPTION OF THE DRAWINGS

FIG. 1 is a plan view showing a structure of a transflective type of liquid crystal display according to a first embodiment of the present invention;

FIG. 2 is a sectional view showing the display taken along line 100-100 according to the first embodiment shown in FIG. 1;

FIG. 3 is a schematic view showing a planar configuration of a convex insulating film in the display according to the first embodiment shown in FIG. 1;

FIGS. 4 to 7 are sectional views for explaining manufacturing processes of the display according to the first embodiment of the present invention;

FIG. 8 is a plan view showing a structure of a display according to a variation of the first embodiment;

FIG. 9 is a sectional view showing the display taken along line 150-150 according to the variation of the first embodiment shown in FIG. 8;

FIG. 10 is a sectional view showing a structure of a transflective type of liquid crystal display according to a second embodiment of the present invention;

FIG. 11 is a sectional view showing a structure of a display according to a first variation of the second embodiment;

FIG. 12 is a sectional view showing a structure of a display according to a second variation of the second embodiment;

FIG. 13 is a plan view showing a structure of a transflective type of liquid crystal display according to a third embodiment of the present invention;

FIG. 14 is a plan view showing a structure of a transflective type of liquid crystal display according to a fourth embodiment of the present invention;

FIG. 15 is a sectional view showing the display taken along line 200-200 according to the fourth embodiment shown in FIG. 14;

FIGS. 16 to 18 are sectional views for explaining manufacturing processes of the display according to the fourth embodiment of the present invention;

FIG. 19 is a plan view showing a structure of a transflective type of liquid crystal display according to a fifth embodiment of the present invention;

FIG. 20 is a sectional view showing the display taken along line 250-250 according to the fifth embodiment shown in FIG. 19;

FIGS. 21 to 24 are schematic views showing a planar configuration of a convex insulating film in the display according to a variation of the present invention;

FIG. 25 is a plan view showing a structure of a conventional transflective type of liquid crystal display having a convex insulating film;

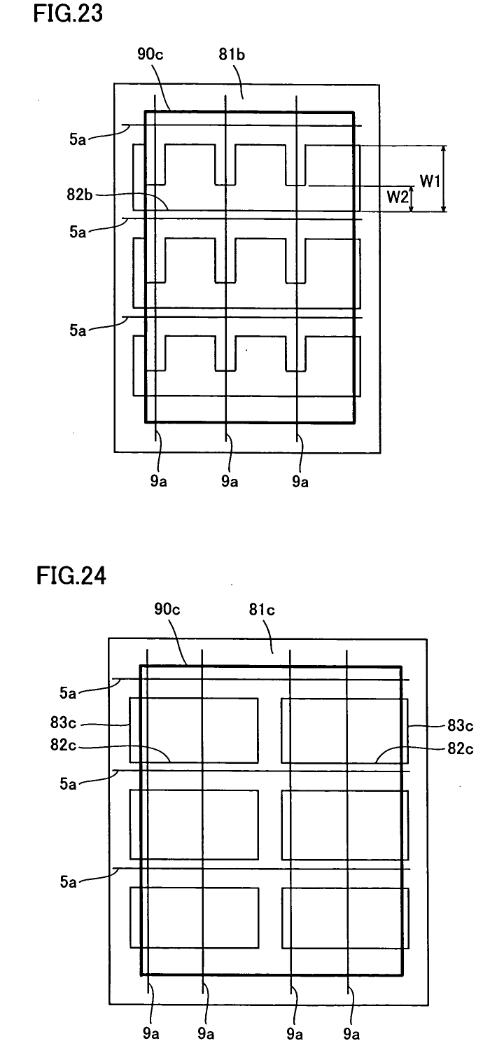

FIG. 26 is a sectional view showing the conventional display taken along line 300-300 in FIG. 25;

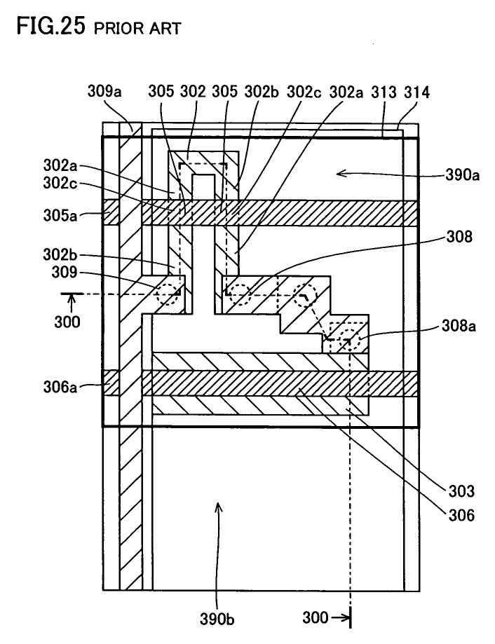

FIG. 27 is a schematic view showing a planar configuration of a convex insulating film in the conventional display shown in FIG. 25; and

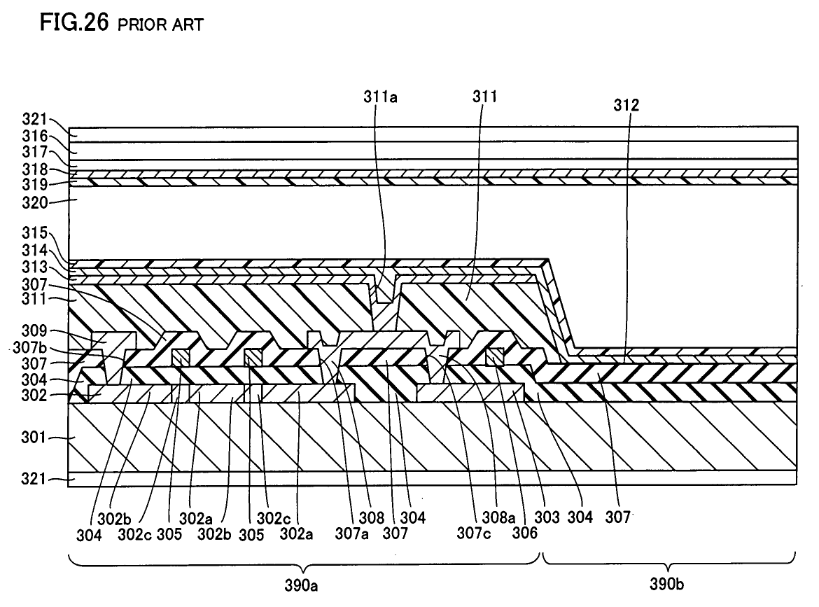

FIG. 28 is a sectional view taken along line 350-350 in FIG. 27.

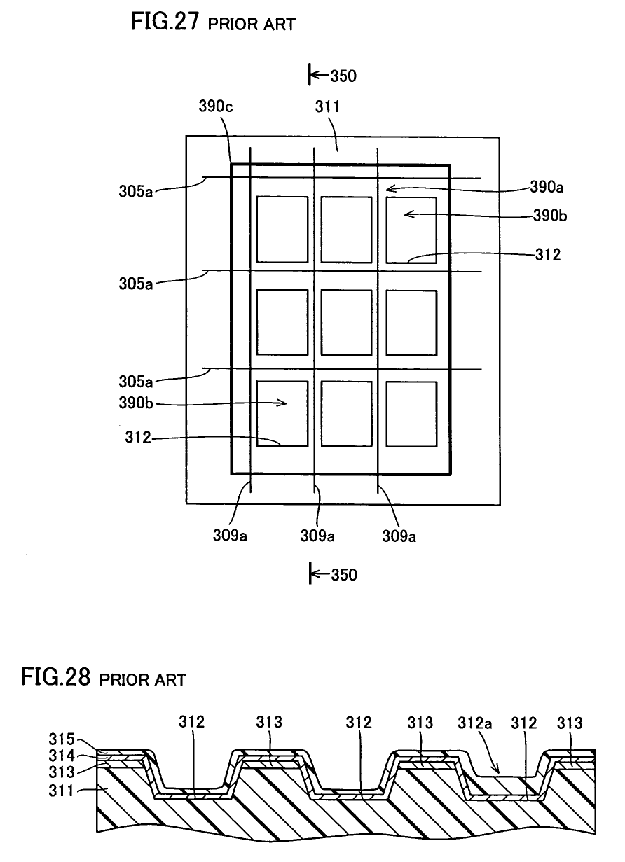

### DESCRIPTION OF THE PREFERRED EMBODIMENTS

Hereinafter, embodiments of the present invention are described with reference to the drawings.

### First Embodiment

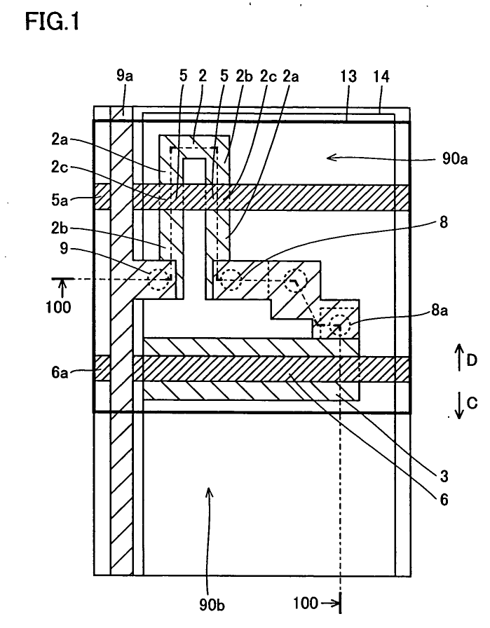

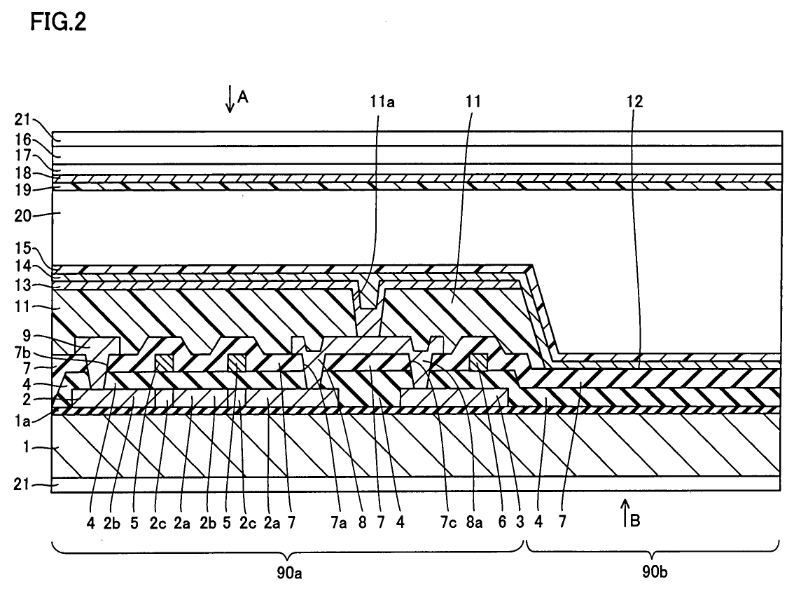

Referring to FIGS. 1 to 3, a transflective type of liquid crystal display according to a first embodiment comprises two regions such as a reflective region 90a and a transmissive region 90b in one pixel. A reflective electrode 13 is formed in the reflective region 90a and a reflective electrode 13 is not formed in the transmissive region 90b. Thus, in the reflective region 91a, an image is displayed by reflecting light in the direction shown by an arrow A in FIG. 2. Meanwhile, in the transmissive region 90b, an image is displayed by transmitting light in the direction shown by an arrow B in FIG. 2.

As a detailed structure according to the first embodiment, as shown in FIG. 2, a semiconductor layer 2 formed of non-monocrystal silicon or amorphous silicon which constitutes a TFT, and a semiconductor layer 3 formed of non-monocrystal silicon or amorphous silicon which functions as an auxiliary capacity electrode are formed in the reflective region 90a on a glass substrate 1 provided with a buffer layer 1a formed of SiNₓ, film and SiO₂ film. In addition, the glass substrate 1 is an example of a “substrate” in the present invention. The semiconductor layer 2 is formed in a horseshoe shape in a plan view as shown in FIG. 1. The semiconductor layer 2 comprises two source regions 2a, two drain regions 2b, and two channel regions 2c as shown in FIG. 2. The source regions 2a and drain regions 2b are arranged so as to sandwich the channel regions 2c, respectively.

In addition, a gate electrode 5 formed of Mo is formed on the two channel regions 2c of the semiconductor layer 2 through a gate insulating film 4 formed of a laminated film comprising a SiNₓ, film and a SiO₂ film. Thus, one gate electrode 5, one source region 2a, one drain region 2b, one channel region 2c, and the gate insulating film 4 constitute one TFT. In addition, the other gate electrode 5, the other source region 2a, the other drain region 2b, the other channel region 2c, and the gate insulating film 4 constitute the other TFT. Furthermore, an auxiliary capacity electrode 6 formed of Mo is formed on the semiconductor layer 3 through the gate insulating film 4. The semiconductor layer 3, the gate insulating film 4 and the auxiliary capacity electrode 6 constitute an auxiliary capacity.

In addition, as shown in FIG. 1, a gate line 5a formed of the same layer as that of the gate electrode 5 and extending in the predetermined direction is connected to the two gate electrodes 5. Furthermore,an auxiliary capacity line 6a formed of the same layer as that of the auxiliary capacity electrode 6 and extending in a direction parallel with the gate line 5a is connected to the auxiliary capacity electrode 6.

Still further, an interlayer insulating film 7 is formed so as to cover the TFT and the auxiliary capacity as shown in FIG. 2. Furthermore, contact holes 7a, 7b and 7c are formed in regions corresponding to the source region 2a, the drain region 2b and the semiconductor layer 3 in the interlayer insulating film 7 and the gate insulating film 4, respectively. A source electrode 8 is formed so as to be electrically connected to the source region 2a through the contact hole 7a. In addition, a part 8a of the source electrode 8 is formed so as to be electrically connected to the semiconductor layer 3 through the contact hole 7c. Furthermore, a drain electrode 9 is formed so as to be electrically connected to the drain region 2b through the contact hole 7b. The source electrode 8 and the drain electrode 9 each comprise a Mo layer, an Al layer and a Mo layer from the lower layer toward the upper layer. In addition, as shown in FIG. 1, a drain line 9a formed of the same layer as that of the drain electrode 9 and extending in the direction perpendicular to the gate line 5a is connected to the drain electrode 9.

Still further, as shown in FIG. 2, a convex insulating film 11 comprising a resin material such as photosensitive acrylic resin having a thickness of about 2 μm to about 3 μm is formed in the predetermined region on the interlayer insulating film 7 so as to cover the source electrode 8 and the drain electrode 9. In addition, according to the first embodiment, a thickness of the convex insulating film 11 is set at about 2.2 μm. A contact hole 11a is formed in a region corresponding to the source electrode 8 in the convex insulating film 11. Thus, a concave part 12 is formed by a side face of the convex insulating film 11 and an upper face of the interlayer insulating film 7 in which the insulating film 11 is not formed. In addition, the convex insulating film 11 is formed so as to correspond to the reflective region 90a and the concave part 12 is formed so as to correspond to the transmissive region 90b. In addition, the concave part 12 is an example of a “second region” of the present invention.

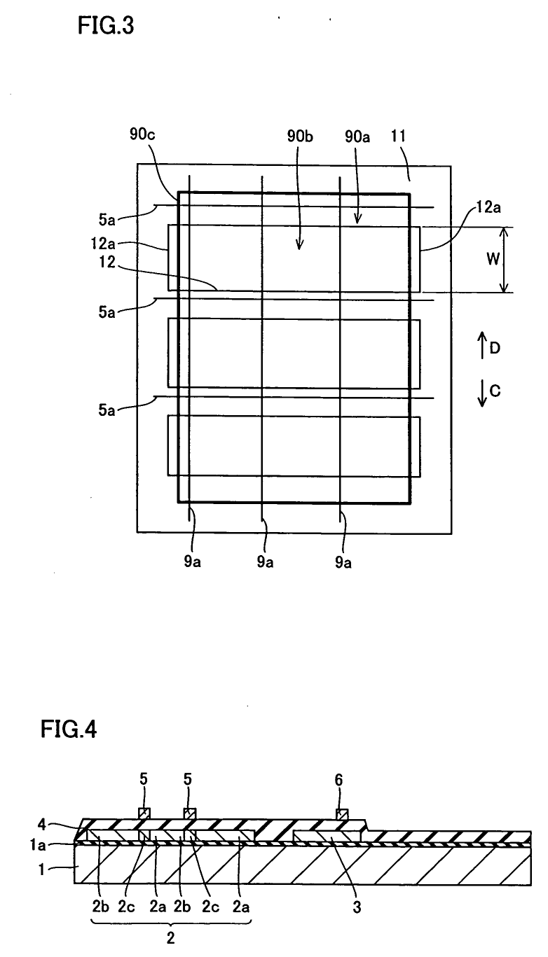

Here, according to the first embodiment, as shown in FIG. 3, the concave part 12 corresponding to the transmissive region 90b of each pixel is continuously formed among adjacent pixels arranged in rows while keeps a constant width W. In addition, the concave part 12 is formed along the extending direction of the gate line 5a to the outside of the display region 90c. That is, both ends 12a of the concave part 12 are disposed outside of the display region 90c.

In addition, as shown in FIG. 2, a reflective electrode 13 comprising Al is formed on the upper face of the convex insulating film 11 so as to be electrically connected to the source electrode 8 through the contact hole 11a. In addition, the reflective electrode 13 is formed so as to cover the TFT, the auxiliary capacity, the gate line 5a and an auxiliary capacity line 6a in a plan view as shown in FIG. 1. Then, as shown in FIG. 2, a transparent electrode 14 comprising IZO (Indium Zinc Oxide) or ITO (Indium Tin Oxide) and having a thickness of about 100 nm to about 150 nm is formed on the inner face of the concave part 12 and on the surface of the reflective electrode 13. In addition, according to the first embodiment, a thickness of the transparent electrode 14 is set at about 100 nm. This transparent electrode 14 and the reflective electrode 13 constitute a pixel electrode. An orientation film 15 comprising polyimide and having a thickness of about 20 nm to about 100 nm is formed on the transparent electrode 14 which constitutes the pixel electrode. A rubbing process (orientation process) has been performed on the orientation film 15 in the direction shown by arrows C in FIGS. 1 and 3. In addition, according to the first embodiment, a thickness of the orientation film 15 is set at about 30 nm.

In addition, as shown in FIG. 2 a glass substrate (opposite substrate) 16 is provided at a position opposed to the glass substrate 1. A color filter 17 which has a thickness of about 1.5 μm to about 2.5 μm and provides colors such as red (R), green (G) and blue (B) is formed on the glass substrate 16. According to the first embodiment, a thickness of the color filter is set at about 1.8 μm. On the color filter 17, a transparent electrode 18 having a thickness of about 100 nm to about 150 nm and comprising IZO or ITO is formed. According to the first embodiment, a thickness of the transparent electrode 18 is set at about 100 nm. On the transparent electrode 18, an orientation film 19 having a thickness of about 20 nm to about 100 nm and comprising polyimide is formed. According to the first embodiment, a thickness of the orientation film 19 is set at about 30 nm. The rubbing process (orientation process) has been performed on the orientation film 19 in the direction shown by arrows D in FIGS. 1 and 3.

A liquid crystal layer 20 is provided between the orientation film 15 and the orientation film 19. A thickness of the liquid crystal layer 20 in the reflective region 90a in which the convex insulating film 11 is provided by patterning the insulating film 11 having a thickness of about 2 μm to about 3 μm in the region corresponding to the reflective region 90a on the interlayer insulating film 7 is a half of the thickness of the liquid crystal layer 20 in the transmissive region 90b in which the convex insulating film 11 is not formed. In addition, according to the first embodiment, a thickness of the convex insulating film 11 is set at about 2.2 μm. Thus, while the liquid crystal layer 20 transmits light two times in the reflective region 90a, the liquid crystal layer 20 in the transmissive region 90b transmits light only one time, so that a light path lengths in the reflective region 90a and the transmissive region 90b become equal by setting the thickness of the liquid crystal layer 20 in the reflective region 90a at a half of the thickness of the liquid crystal layer 20 of the transmissive region 90b. Thus, fluctuation in display quality between the transmissive display and the reflective display can be reduced. In addition, on a back face of the glass substrate 1 and on a back face of the glass substrate (opposite substrate) 16, an elliptical polarization film 21 having a thickness about 0.4 mm to about 0.8 mm is formed respectively. According to the first embodiment, a thickness of the elliptical polarization film 21 is set at about 0.5 mm.

According to the first embodiment, as described above, the concave part 12 corresponding to the transmissive region 90b of each pixel is continuously formed among pixels in the same row. Therefore, when the orientation film 15 is formed on the transparent electrode 14 having a concave configuration which reflects the concave part 12, the orientation film 15 can flow along the concave region corresponding to the concave part 12, among pixels. Thus, since the orientation film 15 can be prevented from staying too much only in the concave region corresponding to the concave part 12 in a part of the pixel, the thickness of the orientation film 15 formed in the concave region corresponding to the concave part 12 can be substantially uniform at each pixel. As a result, deterioration of display quality caused by the fluctuation of the thickness of the orientation film 15 formed in the concave region corresponding to the concave part 12 can be prevented.

Furthermore, according to the first embodiment, both ends 12a of the concave part 12 are disposed outside of the display region 90c. That is, the end 12a of the concave part 12 in the row direction does not overlap with the reflective electrode 13 nor the transmissive electrode 14. Therefore, since both ends 12a of the concave region corresponding to the concave part 12 in which the orientation film 15 is likely to stay are not positioned in the display region 90c, the orientation film 15 disposed in the concave region in the display region 90c can be easily formed with uniform thickness. Thus, the deterioration in display quality can be further prevented.

A description is given of manufacturing processes of the transflective type of liquid crystal display according to the first embodiment with reference to FIGS. 1 to 7.

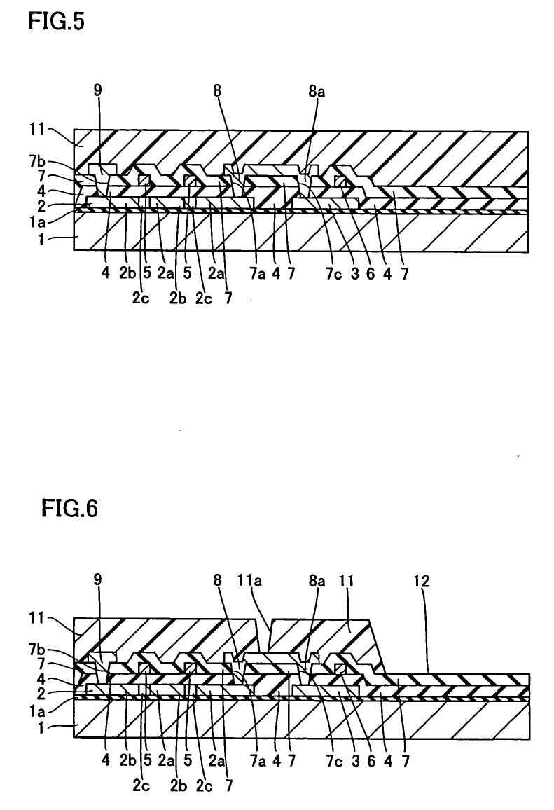

First, as shown in FIG. 4, the semiconductor layer 2 constituting the TFT and the semiconductor layer 3 functioning as the auxiliary capacity electrode are formed in the predetermined region on the glass substrate 1 provided with the buffer layer 1a. The semiconductor layer 2 is formed into the horseshoe shape in a plan view as shown in FIG. 1. In addition, when the semiconductor layers 2 and 3 are formed of amorphous silicon, they are preferably crystallized. Then, the gate electrode 5 is formed on the semiconductor 2 through the gate insulating film 4. Then, two sets of source regions 2a and drain regions 2b are formed by ion implantation into the semiconductor layer 2 using the gate electrode 5 as a mask. Thus, two TFT's are formed.

In addition, the auxiliary capacity electrode 6 is formed on the gate insulating film 4 on the semiconductor layer 3. Thus, the auxiliary capacity is formed by the semiconductor layer 3, the gate insulating film 4 and the auxiliary capacity electrode 6. In addition, as shown in FIG. 1, the gate line 5a extending in the predetermined direction is formed of the same layer as that of the two gate electrodes 5. Furthermore, the auxiliary capacity line 6a extending in the direction parallel to the gate line 5a is formed of the same layer as that of the auxiliary capacity electrode 6. The auxiliary capacity electrode 6 and the auxiliary capacity line 6a are preferably formed at the same time when the gate electrode 5 and the gate line 5a are patterned.

Then, as shown in FIG. 5, the interlayer insulating film 7 is formed so as to cover the whole surface. Then, the contact holes 7a, 7b and 7c are formed in the regions corresponding to the source region 2a, the drain region 2b and the semiconductor layer 3 in the interlayer insulating film 7 and the gate insulating film 4, respectively.

Then, the source electrode 8 is formed so as to be electrically connected to the source region 2a through the contact hole 7a. At this time, the part 8a of the source electrode 8 is electrically connected to the semiconductor layer 3 through the contact hole 7c. The drain electrode 9 is formed so as to be electrically connected to the drain region 2b through the contact hole 7b. In addition, as shown in FIG. 1, the drain line 9a extending in the direction perpendicular to the gate line 5a is formed at the same time with drain electrode 9 by the same layer as that of the drain electrode 9. Then, the insulating film 11 is formed so as to cover the whole surface.

Then, as shown in FIG. 6, the convex insulating film 11 is formed in the reflective region 90a by patterning the insulating film 11. At this time, according to the first embodiment, as shown in FIG. 3, the insulating film 11 is patterned in such a manner that the concave part 12 positioned in the transmissive region 90b in which the convex insulating film 11 is not formed may have a continuous configuration among pixels in the same row. In addition, the insulating film 11 is patterned in such a manner that both ends 12a of the concave part 12 may be disposed outside of the display region 90c. Then, as shown in FIG. 6, the contact hole 11a is formed in the region corresponding to the source electrode 8 of the insulating film 11.

Then, the reflective electrode 13 is formed on the upper surface of the convex insulating film 11 so as to be electrically connected to the source electrode 8 through the contact hole 11a as shown in FIG. 7. In addition, the transparent electrode 14 is formed on the inner surface of the concave part 12 and on the surface of the reflective electrode 13. Thus, the pixel electrode comprising the transparent electrode 14 and the reflective electrode 13 is formed.

Then, the orientation film 15 comprising polyimide is formed on the transparent electrode 14 constituting the pixel electrode using a roller transfer method or the like. At this time, according to the first embodiment, as shown in FIG. 3, since the concave part 12 is continuously formed among pixels, polyimide constituting the orientation film 15 flows along the concave part 12 among pixels. Thus, the thickness of the orientation film 15 formed on the concave part 12 can be uniformly provided among pixels.

Then, as shown in FIG. 2, the color filter 17, the transparent electrode 18 and the orientation film 19 are sequentially formed on the glass substrate (opposite substrate) 16 provided so as to be opposed to the glass substrate 1. Then, the liquid crystal layer 20 is provided between the orientation film 15 and the orientation film 19. Then, the elliptical polarization film 21 is formed on the back face of the glass substrate 1 and on the back face of the glass substrate (opposite substrate) 16, respectively, whereby the transflective type of liquid crystal display according to the first embodiment is formed.

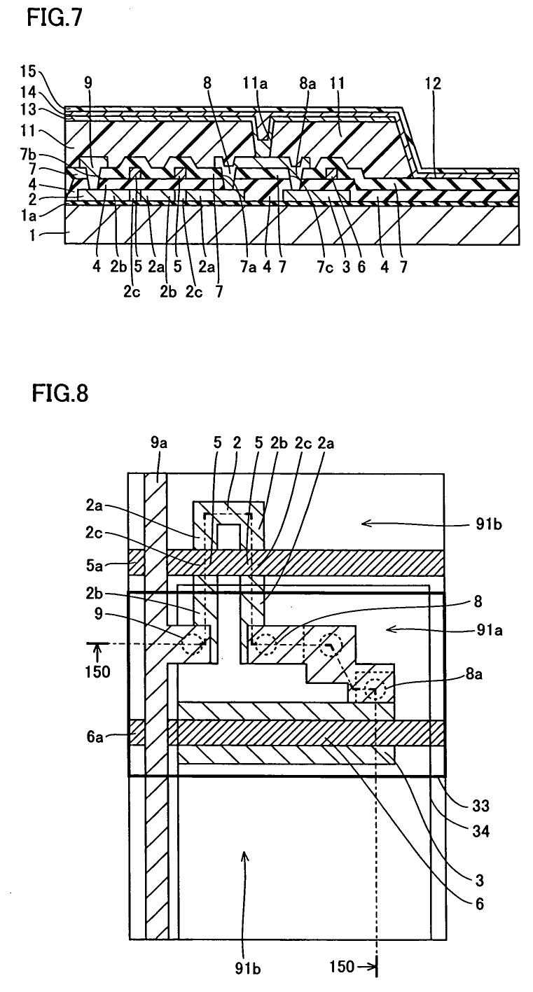

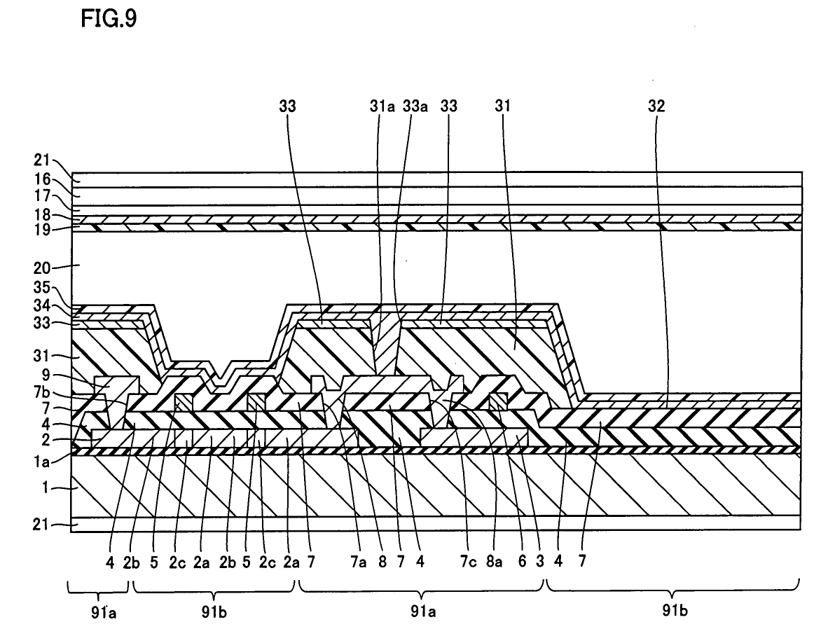

According to a variation of the first embodiment, with reference to FIGS. 8 and 9, a description is given of a case where a convex insulating film 31 corresponding to a reflective region 91a is not formed in the upper region of the gate electrode 5 and the gate line 5a, in the structure according to the first embodiment. That is, according to the variation of the first embodiment, two concave parts 32 (transmissive region 91b) are formed so as to sandwich the reflective region 91a in which the convex insulating film 31 is formed in one pixel. In addition, the concave part 32 is an example of the “second region” of the present invention.

More specifically, according to the variation of the first embodiment, the convex insulating film 31 is formed of a resin material such as a photosensitive acrylic resin and has a thickness of about 2 μm to about 3 μm. In this variation of the first embodiment, a thickness of the convex insulating film 31 is set at about 2.2 μm. Then, as shown in FIG. 9, a reflective electrode 33 having a contact hole 33a in the region corresponding to the source electrode 8 is formed on the upper face of the convex insulating film 31. In addition, a transparent electrode 34 having a thickness of about 100 nm to about 150 nm and comprising IZO or ITO is formed so as to be electrically connected to the source electrode 8 through the contact holes 31a and 33a, and extends along on the inner surface of the concave part 32 and on the surface of the reflective electrode 33. In the variation of the first embodiment, a thickness of the transparent electrode 34 is set at about 100 nm. The transparent electrode 34 and the reflective electrode 33 constitute the pixel electrode. On the transparent electrode 34, an orientation film 35 having a thickness of about 20 nm to about 100 nm and comprising polyimide is formed. According to the variation of the first embodiment, a thickness of the orientation film 35 is set at about 30 nm.

In the transflective type of liquid crystal display according to the variation of the first embodiment, the region in which the reflective electrode 33 is formed on the upper face of the convex insulating film 31 is reduced by enlarging the region in which the concave part 32 is formed in the transmissive region 90b. Therefore, the transflective type of liquid crystal display according to the variation of the first embodiment has the reflective region 91a smaller than the reflective region 90a in the first embodiment, and has the transmissive region 91b larger than the transmissive region 90b in the first embodiment. Thus, even when the sizes of the reflective region 91a and the transmissive region 91b are changed, similar to the first embodiment, the thickness of the orientation film 35 formed in the concave region corresponding to the concave part 32 can be uniform.

In addition, as can be clear from comparison between FIGS. 1 and 8, it is not necessary to dispose TFT and the auxiliary capacity so as to overlap with the reflective region 9Oa. However, the TFT and the auxiliary capacity become light shielding regions. Therefore, the region in which the TFT and the auxiliary capacity are provided is preferably the reflective region.

### Second Embodiment

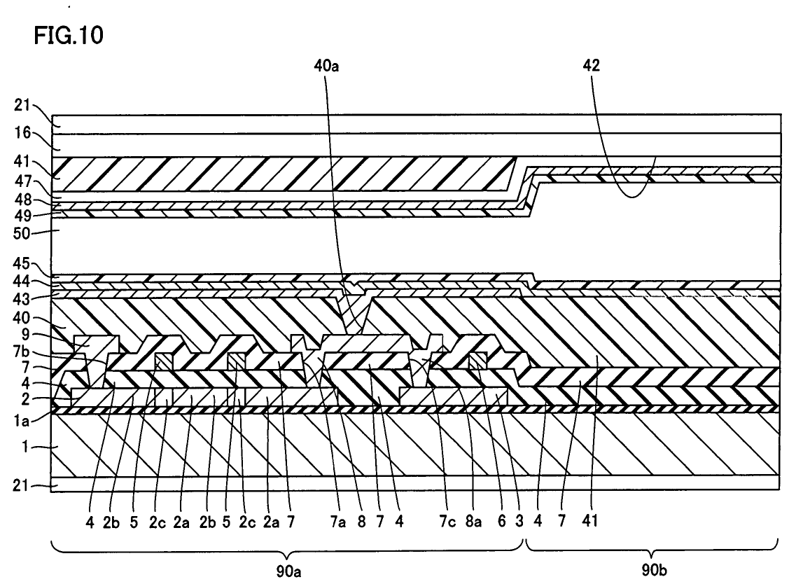

Referring to FIG. 10, according to a second embodiment, a description is given of a case where a concave part is formed an opposite substrate by forming a convex insulating film on the opposite substrate, unlike the first embodiment in which the convex insulating film is formed on the substrate in which the TFT is provided.

According to the second embodiment, a flat film 40 having a contact hole 40a in a region corresponding to a source electrode 8 has been formed so as to cover the source electrode 8 and a drain electrode 9. A reflective electrode 43 comprising Al is formed on the flat film 40 in the reflective region 90a so as to be electrically connected to the source electrode 8 through the contact hole 40a. Then, a transparent electrode 44 having a thickness of about 100 nm to about 150 nm and comprising IZO or ITO is formed so as to cover the reflective electrode 43. In addition, according to the second embodiment, a thickness of the transparent electrode 44 is set at about 100 nm. The transparent electrode 44 and the reflective electrode 43 constitute a pixel electrode. In addition, an orientation film 45 having a thickness of about 20 nm to about 100 nm and comprising polyimide is formed on the transparent electrode 44 constituting the pixel electrode. In addition, according to the second embodiment, a thickness of the orientation film 45 is set at about 30 nm.

A glass substrate (opposite substrate) 16 is provided at a position opposed to a glass substrate 1. A convex insulating film 41 is formed on the glass substrate 16. Thus, a concave part 42 is formed by a side face of the convex insulating film 41 and an upper face of the glass substrate 16 in which the insulating film 41 is not formed. The convex insulating film 41 and the concave part 42 correspond to the convex insulating film 11 and the concave part 12 in the first embodiment shown in FIG. 2. In addition, the concave part 42 is an example of the “second region” of the present invention.

According to the second embodiment, like the first embodiment shown in FIG. 3, the concave part 42 corresponding to the transmissive region 90b in each pixel is continuously formed among adjacent pixels arranged in rows while keeps a constant width. In addition, the concave part 42 is formed along the extending direction of a gate line (not shown) to the outside of a display region (not shown). That is, both ends (not shown) of the concave part 42 are disposed outside of the display region.

In addition, a color filter 47, a transparent electrode 48 and an orientation film 49 which are the same as in the first embodiment are formed on the upper face of the insulating film 41 and on the inner surface of the concave part 42. The color filter 47, the transparent electrode 48 and the orientation film 49 are formed into a concavo-convex configuration which reflects the convex insulating film 41 and the concave part 42. In addition, a liquid crystal layer 50 is provided between the orientation film 45 and the orientation film 49.

According to the second embodiment, as described above, the concave part 42 corresponding to the transmissive region 90b in each pixel provided in the glass substrate (opposite substrate) 16 is continuously formed among pixels in the same row. Therefore, when the orientation film 49 is formed on the transparent electrode 48 having a concave configuration which reflects the concave part 42, the orientation film 49 can flow along the concave region corresponding to the concave part 42 among pixels. Thus, since the orientation film 49 can be prevented from staying too much only in the region corresponding to the concave part 42 in a part of the pixel, the thickness of the orientation film 49 formed in the concave region corresponding to the concave part 42 can be substantially uniform in each pixel. As a result, deterioration in display quality caused by fluctuation in thickness of the orientation film 49 formed in the concave region corresponding to the concave part 42 can be prevented.

In addition, according to the second embodiment, as described above, since the color filter 47 is formed on the upper face of the convex insulating film 41 and the inner face of the concave part 42, a material constituting the color filter 47 is likely to stay on the inner face of the concave part 42. As a result, a thickness of the color filter 47 positioned on the upper face of the convex insulating film 41 can be easily differentiated from a thickness of the color filter 47 positioned on the inner face of the concave part 42. Consequently, two kinds of colors can be easily displayed with one kind of color filter 47.

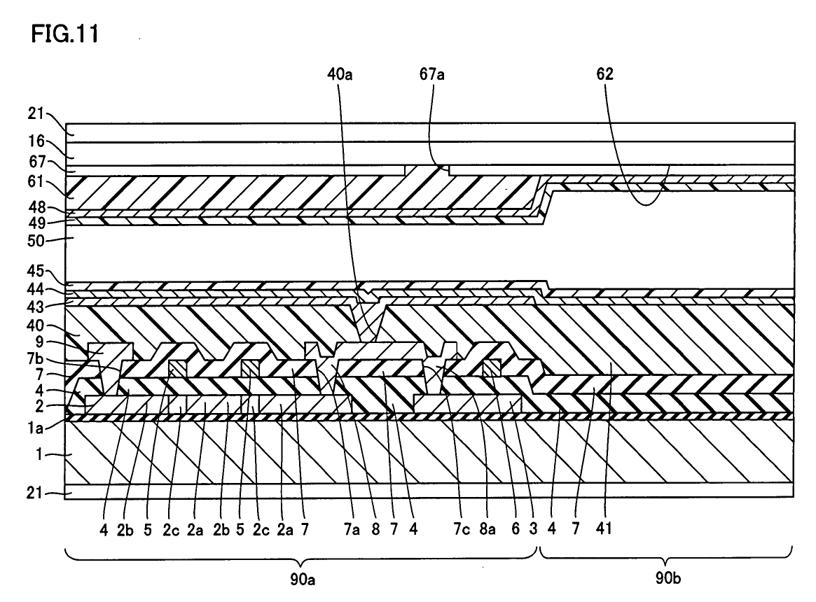

Referring to FIG. 11, in a transflective type of liquid crystal display according to a first variation of the second embodiment, a color filter 67 having an opening 67a is formed between a glass substrate (opposite substrate) 16 and a convex insulating film 61 in a region corresponding to a reflective region 90a. A concave part 62 is constituted by a side face of the convex insulating film 61 and an upper face of the color filter 67 in which the insulating film 61 is not formed. The insulating film 61 is formed of a resin material such as a photosensitive acrylic resin having a thickness of about 2 μm to about 3 μm. In the variation of the second embodiment, a thickness of the convex insulating film 61 is at about 2.2 μm. In addition, the concave part 62 is an example of the “second region” of the present invention. In addition, the same transparent electrode 68 and the orientation film 69 as in the second embodiment are formed on the upper face of the insulating film 61 and inner face of the concave part 62.

According to the variation of the second embodiment, since a part of light input to the reflective region 90a through a color filter 67 passes through the opening 67a without passing the color filter 67 again, lowering of light intensity caused when the light input to the reflective region 90a passes through the color filter 67 again can be prevented. As a result, since reflection coefficient of the light input to the reflective region 90a can be improved, luminance can be enhanced.

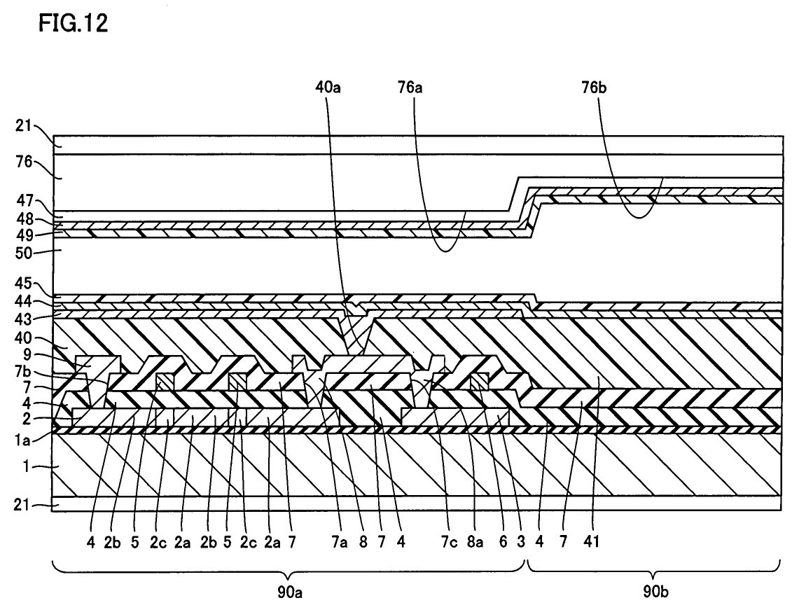

Referring to FIG. 12, in a transflective type of liquid crystal display according to a second variation of the second embodiment, a convex part 76a is formed by etching a glass substrate (opposite substrate) 76. A concave part 76b is constituted by the convex part 76a and a surface of the glass substrate 76 other than the convex part 76a. In addition, the convex part 76a is an example of an “insulating film” and an “insulating part” of the present invention, and the concave part 76b is an example of the “second region” of the present invention. According to the second variation of the second embodiment, as described above, the convex part 76a is formed by etching the glass substrate (opposite substrate) 76. Thus, the manufacturing processes can be further simplified by using the above film forming step and the etching step as compared with the case where the convex insulating film is newly formed on the glass substrate 76.

### Third Embodiment

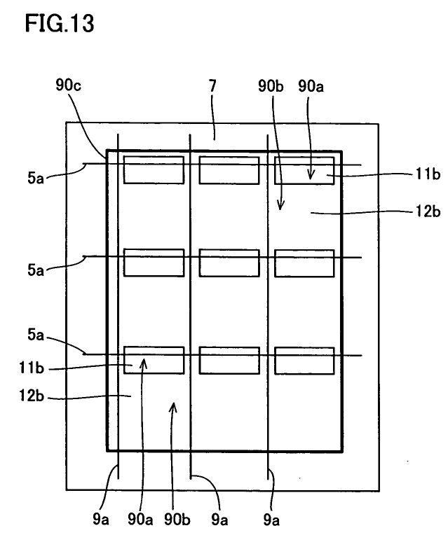

According to a third embodiment, a description is given of a case where a convex insulating film is formed into the shape of an island so that a region in which a convex insulating film is not formed is continuous among adjacent pixels arranged in rows, and continuous at a part among adjacent pixels arranged in columns, in the structure of the first embodiment, with reference to FIG. 13.

That is, according to the third embodiment, as shown in FIG. 13, a convex insulating film 11b comprising the same resin material in the first embodiment is formed into the shape of the island only in a region corresponding to a gate line 5a other than a region corresponding to a drain line 9a on an interlayer insulating film 7. Thus, a region 12b in which the convex insulating film 11b is not formed in the transmissive region 90b of each pixel is formed so as to be continuous among adjacent pixels arranged in rows, and to be continuous in a region corresponding to the drain line 9a among the adjacent pixels arranged in columns. In addition, the region 12b in which the convex insulating film 11b is not formed corresponds to the concave part 12 in the first embodiment. In addition, the region 12b is an example of the “second region” of the present invention.

According to the third embodiment, as described above, the region 12b in which the convex insulating film 11b is not formed in the transmissive region 90b of each pixel is formed so as to be continuous among the adjacent pixels arranged in rows, and to be continuous in the region corresponding to the drain line 9a among the adjacent pixels arranged in columns, by forming the convex insulating film 11b into the shape of the island in only the region corresponding to the gate line 5a other than the region corresponding to the drain line 9a. As a result, when an orientation film is formed, the orientation film can flow in the direction not only in rows but also in columns. Thus, as compared with the first embodiment, since the orientation film is further prevented from staying too much at a part of the pixels, deterioration in display quality caused by the fluctuation in thickness of the orientation film can be further prevented.

Next, a description is given of a case where in a display having a reflective region, a diffusion structure is provided in a reflective electrode.

### Fourth Embodiment

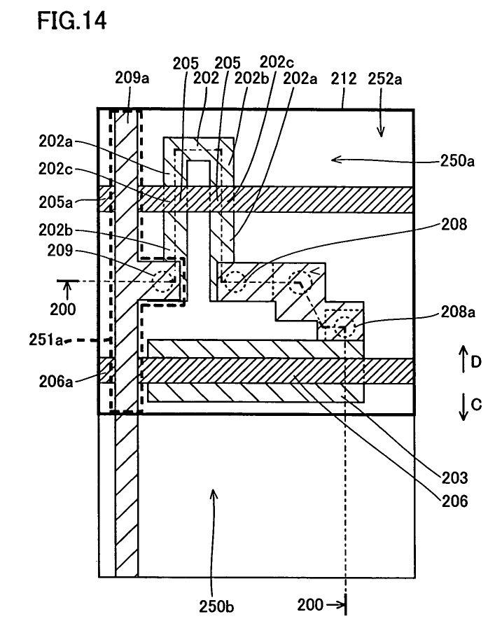

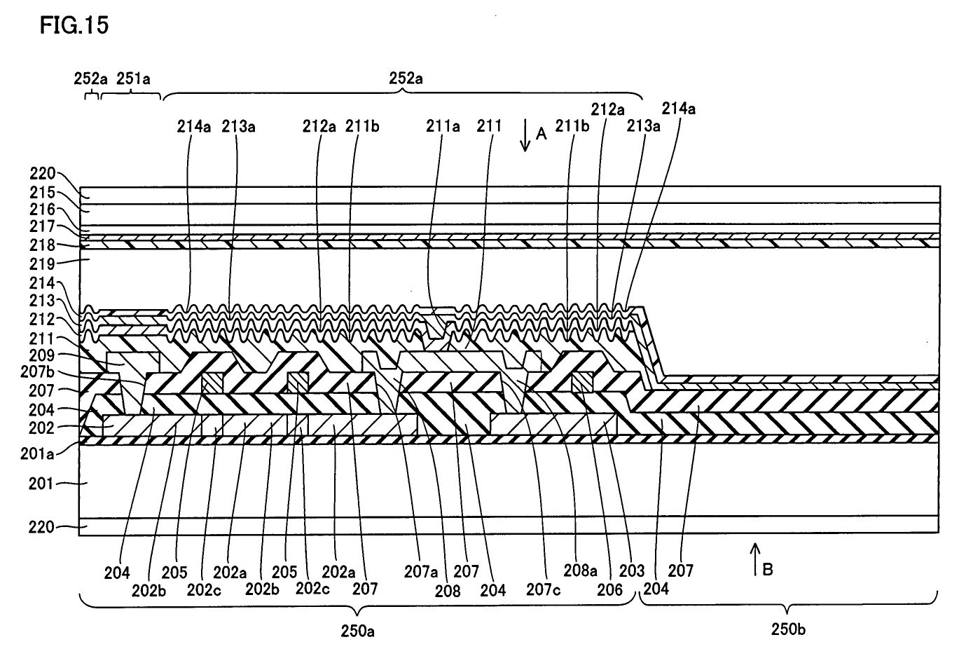

Referring to FIGS. 14 and 15, a transflective type of liquid crystal display according to a fourth embodiment has two regions such as a reflective region 250a in which a reflective region 212 is formed and a transmissive region 250b in which the reflective region 212 is not formed, in one pixel.

As a detailed structure in the fourth embodiment, as shown in FIG. 15, similar to the above-mentioned embodiments, a TFT provided with a semiconductor layer 202, a gate insulating film 203, and a gate electrode 205, and an auxiliary capacity provided with a semiconductor layer 203, a gate insulating film 204, and one auxiliary capacity electrode 206 are formed on the glass substrate 201 provided with a buffer layer 201a. The semiconductor layer 202 comprises a source region 202a, a drain region 202b, and a channel region 202c.

As shown in FIG. 15, an interlayer insulating film 207 is formed so as to cover the TFT and the auxiliary capacity. In addition, a source electrode 208 and a drain electrode 209 are formed through contact holes 207a and 207b of the interlayer insulating film 207 and the gate insulating film 204. In addition, a part 208a of the source electrode 208 is formed so as to be electrically connected to the semiconductor layer 203 through the contact hole 207c.

Furthermore, as shown in FIG. 15, a convex insulating film 211 is formed so as to cover the source electrode 208 and the drain electrode 209. Then, a reflective electrode 212 is formed through the contact hole 211a of the convex insulating film 211.

Here, according to the fourth embodiment, as shown in FIG. 15, a concavo-convex part 211b for forming a diffusion structure 212a at the reflective electrode 212 is provided only in a region 252a other than a region 251a corresponding to the drain electrode 209 and the drain line 209b (referring to FIG. 14). That is, the concavo-convex part 211b is not provided in the region 251a. In addition, a depth of the concavo-convex part 211b from the upper face of the convex part to the bottom face of the concave part is about 0.7 μm.

According to the fourth embodiment, as described above, it is not necessary to form the concavo-convex part 211b for the diffusion structure 212a on the upper face of the convex insulating film 211 of the region 251a corresponding to the drain electrode 209 and the drain line 209a in which the reflective electrode 212 having no diffusion structure 212a is formed. Thus, short-circuit by contact between the drain electrode 209 and the drain line 209a, and the reflective electrode 212 caused because the concave part of the concave-convex part 211b becomes too large is not generated. Consequently, since the short-circuit defect can be prevented, lowering of yield cause by the short-circuit defect can be prevented. In addition, on the upper face of the convex insulating film 211 of the region 252a, reflective characteristics can be improved by forming the reflective electrode 212 having the diffusion structure 212a. Thus, in the transflective type of liquid crystal display according to the fourth embodiment, while the reflective characteristics are improved, the yield can be prevented from being lowered.

In addition, according to the fourth embodiment, as described above, the region corresponding to the concavo-convex 211b of the reflective electrode 212 formed on the convex insulating film 211 becomes the concavo-convex configuration which reflects the concavo-convex part 211b, by forming the concavo-convex part 211b on the upper face of the convex insulating film 211 in the region 252a. Consequently, the reflective electrode 212 having the diffusion structure 212a of the concavo-convex configuration can be easily formed in the region 252a.

Next, referring to FIGS. 14 to 18, a description is given of manufacturing processes of the transflective type of liquid crystal display according to the fourth embodiment.

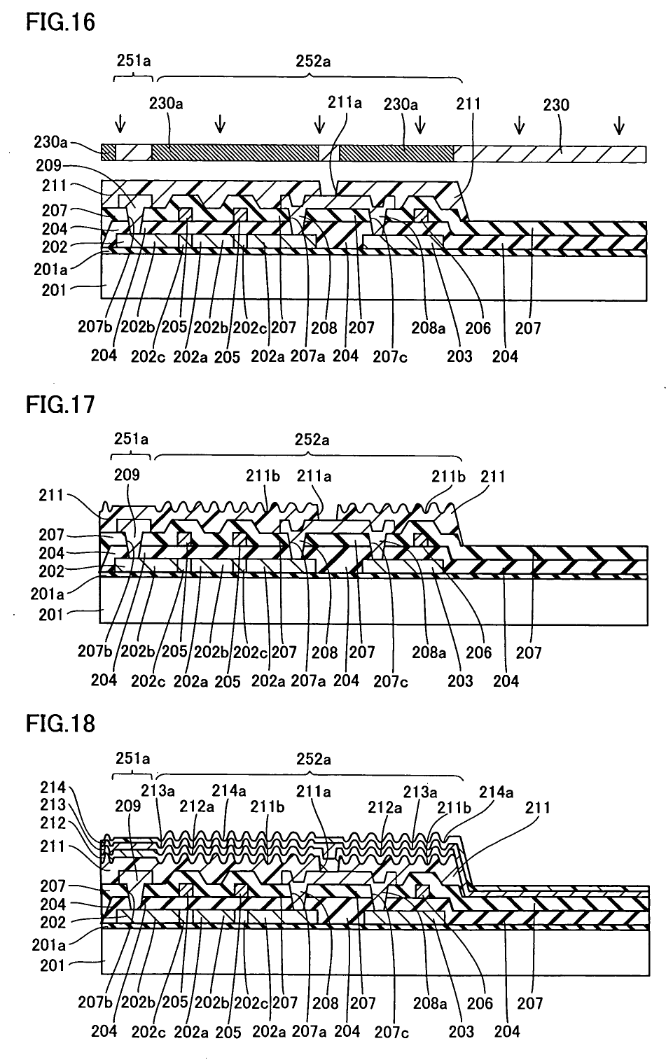

Then, as shown in FIG. 16, a photomask 230 having a region 230a in which holes are arranged at random is set above the convex insulating film 211. Then, only the predetermined region on the upper face of the convex insulating film 211 is exposed (half-exposed) by using the photomask 230 and developed to form the concavo-convex part 211b in the predetermined region on the upper face of the convex insulating film 211 as shown in FIG. 17. At this time, according to the fourth embodiment, the exposure and development are performed so as to form the concavo-convex part 211b only in the region 252a other than the region 251a corresponding to the drain electrode 209 and the drain line 209a (referring to FIG. 14). Thus, even when the concave part of the concavo-convex part 211b becomes too deep, the surface of the drain electrode 209 and the drain line 209a (referring to FIG. 14) is prevented from being exposed.

Then, as shown in FIG. 18, the reflective electrode 212 is formed on the convex insulating film 211 so as to be electrically connected to the source electrode 208 through the contact hole 211a. At this time, in the reflective electrode 212, the diffusion structure 212a of the concavo-convex configuration which reflects the concavo-convex 211b on the upper face of the convex insulating film 211 is formed only in the region 252a other than the region 251a corresponding to the drain electrode 209 and the drain line 209a (referring to FIG. 14).

Then, the transparent electrode 213 is formed so as to cover the convex insulating film 211 and the reflective electrode 212. At this time, in the transparent electrode 213, the concavo-convex part 213a which reflects the concavo-convex part 211b on the upper face of the convex insulating film 211 is formed in the region 252a other than the region 251a corresponding to the drain electrode 209 and the drain line 209a (referring to FIG. 14). Thus, the pixel electrode comprising the transparent electrode 213 and the reflective electrode 212 is formed. Then, the orientation film 214 is formed on the transparent electrode 213 using a roller transfer method or the like. At this time, in the orientation film 214, the concavo-convex part 214a which reflects the concavo-convex part 211b on the upper face of the convex insulating film 211 is formed in the region 252a other than the region 251a corresponding to the drain electrode 209 and the drain line 209a (referring to FIG. 14).

### Fifth Embodiment

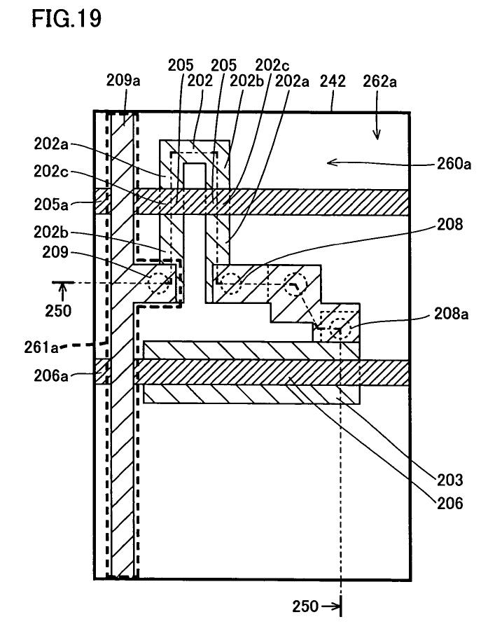

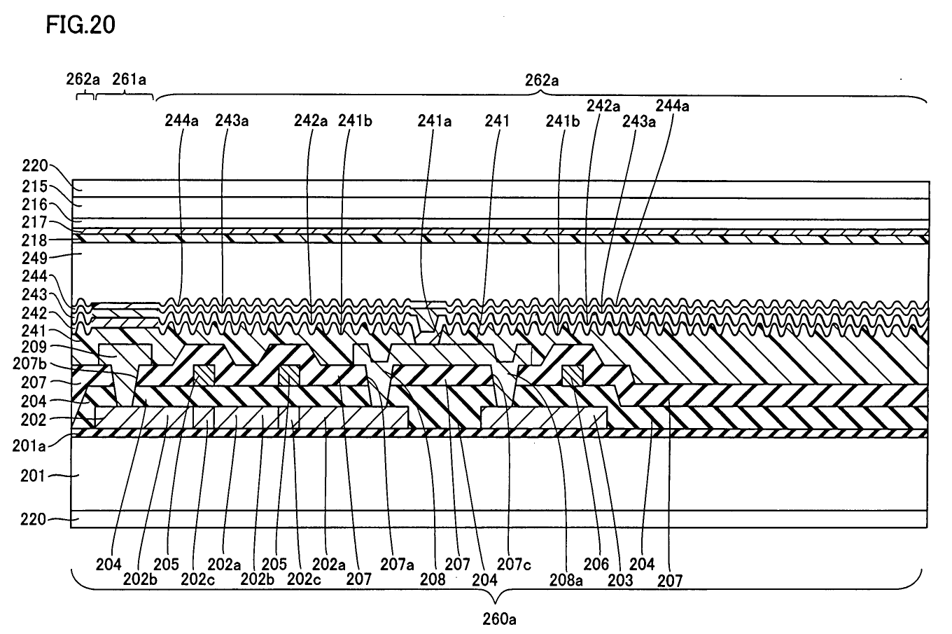

Referring to FIGS. 19 and 20, in a fifth embodiment, a description is mainly made of a part which is different from the fourth embodiment in that only a reflective region 260a is provided in one pixel in the reflective type of liquid crystal display.

According to the fifth embodiment, unlike the fourth embodiment, the reflective region 260a is only provided and the transmissive region is not provided. Therefore, according to the fifth embodiment, it is not necessary to differentiate the thickness of the liquid crystal layer between the reflective region and the transmissive region by providing the convex insulating film. Therefore, according to the fifth embodiment, unlike the fourth embodiment, a substantially flat insulating film 241 is formed. A reflective electrode 242 is formed on the insulating film 241 in each pixel so as to be electrically connected to a source electrode 208 through a contact hole 241a.

In addition, according to the fifth embodiment, as shown in FIG. 20, a concavo-convex part 241b for forming a diffusion structure 242a in a reflective electrode 242 is provided only in a region 262a other than a region 261a corresponding to a drain electrode 209 and a drain line 209a (referring to FIG. 19) on an upper face of the substantially flat insulating film 241. Therefore, as shown in FIGS. 19 and 20, in the reflective electrode 242, the concavo-convex diffusion structure 242a which reflects the concavo-convex part 241b on the upper face of the substantially flat insulating film 241 is formed only in the region 262a other than the region 261a corresponding to the drain electrode 209 and the drain line 209a.

As shown in FIG. 20, a transparent electrode 243 is formed on the reflective electrode 242. A pixel electrode is constituted by the transparent electrode 243 and the reflective electrode 242. An orientation film 244 is formed on the transparent electrode 243. In addition, in the transparent electrode 243 and the orientation film 244, concavo-convex parts 243a and 244a which reflect the concavo-convex part 241b on the upper face of the substantially flat insulating film 241 are formed in the region 262a other than the region 261a corresponding to the drain electrode 209 and the drain line 209a (referring to FIG. 19).

In addition, effects in the fifth embodiment are the same as those in the fourth embodiment.

In addition, the illustrated embodiments are thought to be illustrative and not restrictive in all respects. The scope of the present invention is not shown by the above description of the embodiments but shown by terms of the appended claims, and various kinds of variation is included in the same meaning and scope as in the claims.

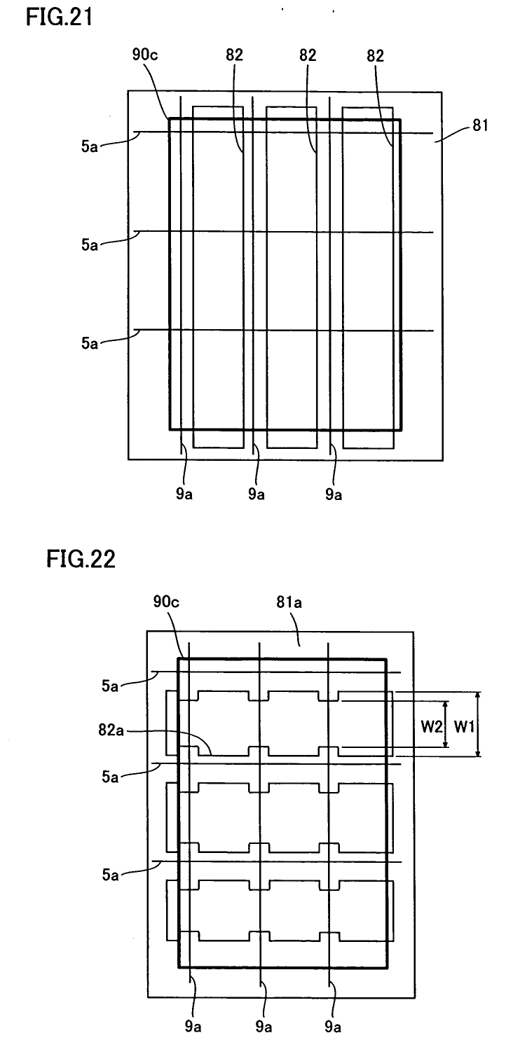

For example, the present invention is not limited to the above first and second embodiments and as shown in FIG. 21, a continuous concave part 82 may be formed among pixels extending along the direction parallel to the drain line 9a. In addition, the concave part 82 is an example of the “second regions” of the present invention.

Furthermore, the present invention is not limited to the above first and second embodiments, and as shown in FIG. 22, a continuous concave part 82a having a narrowed part in which a width is reduced may be formed by projecting the convex insulating film 81a positioned in the region corresponding to the drain line 9a by a predetermined amount in both directions along the drain line 9a. In addition, as shown in FIG. 23, a continuous concave part 82b having a narrowed part in which a width is reduced may be formed by projecting the convex insulating film 81b positioned in the region corresponding to the drain line 9a by a predetermined amount in one direction along the drain line 9a. In addition, the concave parts 82a and 82b are examples of the “second region” of the present invention. When convex insulating film 81a or 81b having the planar configuration shown in FIGS. 22 or 23 is formed, since the region of the convex insulating film 81a or 81b is increased, the reflective region can be increased for that. In addition, since the drain line 9a is formed of metal (Mo and Al), the region of the concave part 82a or 82b corresponding to the drain line 9a becomes a light-shielding region. Therefore, the metal layer such as the drain line 9a is preferably the reflective region as much as possible. However, when the width W2 of the narrowed part is reduced too much for the width Wi of the concave part 82a and 82b, since a flow property of the orientation film is lowered, it is preferably set that W2 / W1 >¾.

I addition, the present invention is not limited to the above first and second embodiments, and as shown in FIG. 24, a concave part 82c extending along the gate line 5a may be divided into two and only one end 83c of the divided concave part 82c may be disposed outside of a display region 90c. In addition, the concave part 82c is an example of the “second region” of the present invention.

Still further, the present invention is not limited to the above first to third embodiments, and a thin film transistor in which each of a source region, a drain region and channel region is provided may be formed in a semiconductor layer having a horseshoe shape.

1. A display including a display region having a reflective region and a transmissive region, comprising;
a first region having a convex insulating film formed in a region corresponding to said reflective region on a substrate; and
an orientation film formed so as to cover said convex insulating film,
wherein a second region in which said convex insulating film is not formed is continuously formed among adjacent pixels.

2. The display according to claim 1,
wherein at least one end of said second region is disposed outside of said display region.

3. The display according to claim 2,
wherein both ends of said second region are disposed outside of said display region.

4. The display according to claim 1,
wherein said second region is continuously formed among adjacent pixels arranged in the first direction.

5. The display according to claim 1,
wherein said second region is continuously formed among the adjacent pixels arranged in the first direction and second direction which intersects with the first direction.

6. The display according to claim 1,
wherein said substrate comprises a substrate in which a thin-film transistor is formed, or an opposite substrate in which said thin-film transistor is not formed.

7. The display according to claim 6,
wherein said substrate is said opposite substrate in which the thin-film transistor is not formed, and further comprises a color filter formed between said substrate and said orientation film.

8. The display according to claim 7,
wherein said substrate is said opposite substrate in which the thin-film transistor is not formed, and further comprises a color filter having an opening at a part of a region corresponding to said reflective region.

9. The display according to claim 6,
wherein said substrate is said opposite substrate in which the thin-film transistor is not formed and said convex insulating film comprises an insulating part integrally formed in said substrate.

10. The display according to claim 1,
wherein said second region is continuously formed among the adjacent pixels so as to have a narrowed part between said adjacent pixels.

11. The display according to claim 10,
wherein said narrowed part of said second region is provided in a boundary region between said adjacent pixels.

12. The display according to claim 1,
wherein said second region is formed so as to extend in the first direction and divided into a plurality of regions along said first direction.

13. A display including a display region having a reflective region and a transmissive region and consisting of a plurality of pixels, comprising:
a first region in which an convex insulating film is formed in a region corresponding to said reflective region on a substrate,
a second region in which said convex insulating film is not formed; and
an orientation film formed in common to said first region and said second region,
wherein said second region is continuously formed among adjacent pixels.

14. The display according to claim 13,
wherein at least one end of said second region is disposed outside of said display region.

15. The display according to claim 14,
wherein both ends of said second region are disposed outside of said display region.

16. The display according to claim 13,
wherein said second region is continuously formed among the adjacent pixels arranged in the first direction.

17. The display according to claim 13,
wherein said second region is continuously formed among the adjacent pixels arranged in the first direction and second direction which intersects with the first direction.

18. The display according to claim 13,
wherein said substrate comprises a substrate in which a thin-film transistor is formed, or an opposite substrate in which said thin-film transistor is not formed.

19. The display according to claim 18,
wherein said substrate is said opposite substrate in which the thin-film transistor is not formed, and further comprises a color filter formed between said substrate and said orientation film.

20. The display according to claim 19,
wherein said substrate is said opposite substrate in which the thin-film transistor is not formed, and further comprises a color filter having an opening at a part of a region corresponding to said reflective region.

21. The display according to claim 18,
wherein said substrate is said opposite substrate in which the thin-film transistor is not formed and said convex insulating film comprises an insulating part integrally formed in said substrate.

22. The display according to claim 13,
wherein said second region is continuously formed among said adjacent pixels so as to have a narrowed part between said adjacent pixels.

23. The display according to claim 22,
wherein said narrowed part of said second region is provided in a boundary region between said adjacent pixels.

24. The display according to claim 13,
wherein said second region is formed so as to extend in the first direction and divided into a plurality of regions along said first direction.
